(19) United States
(12) Patent Application Publication
(10) Pub. No.: US 2015/0239058 A1
(43) Pub. Date: Aug. 27, 2015

(54) METHOD AND APPARATUS FOR METAL SHIELD-GAS WELDING

(71) Applicant: MHIW b.v., RC Dronten (NL)

(72) Inventors: Konstantin Alexander BUESCHER, Bocholt (DE); Ralph Wijnholds, JW Dronten (NL)

(21) Appl. No.: 14/621,867

(22) Filed: Feb. 13, 2015

(30) Foreign Application Priority Data
Feb. 21, 2014 (DE) 102014002213.7

(51) Int. Cl. B23K 9/235; B23K 9/173; B23K 9/12; B23K 9/167

(52) U.S. Cl. CPC B23K 9/235; B23K 9/1675; B23K 9/1735; B23K 9/12

(57) ABSTRACT

The invention relates to a method of gas metal arc welding in which an electric arc burns in a shield gas environment during welding for production of a weld along a welding path between at least one workpiece to be welded and a melting wire electrode (1) that is in particular continuously fed to the at least one workpiece. At the starting end of the weld to be produced, chronologically before ignition of the electric arc between the at least one workpiece and the wire electrode (1), a nonconsumable electrode (2) is moved toward the at least one workpiece. Between the at least one workpiece and the nonconsumable electrode (2), in a shield gas environment an electric arc is ignited that locally preheats the at least one workpiece at the starting ending end of the weld to be produced. After the preheating the nonconsumable electrode (2) is removed from the at least one workpiece and after removal of the nonconsumable electrode (2) the electric arc is ignited between the at least one workpiece and the wire electrode. The invention further relates to a torch head for carrying out the method.

The invention relates to a method of gas metal arc welding in which an electric arc burns in a shield gas layer during the welding for production of a weld along a welding path between at least one workpiece to be welded and a melting wire electrode that is in particular continuously delivered to the at least one workpiece. The invention also relates to a torch head for gas metal arc welding.

Gas metal arc welding, also abbreviated as GMAW welding, is known in the prior art and has the advantages that the melting metal of a wire electrode delivered in particular continuously to the workpiece during welding and also the melting metal of at least one workpiece to be welded is protected by a shield gas against the oxidizing ambient atmosphere during the welding process.

In this case it is also known that for example inert gases such as argon or helium can be used as a shield gas, the welding method then being designated as MIG welding, or also that as shield gas an active or reactive shield gas, such as for example carbon dioxide or a mixture of carbon dioxide and argon is used, which is then designated as MAG welding. The selection of the type of shield gas is made substantially as a function of the material of the at least one workpiece to be welded.

In these welding methods torches that have a wire feed for the wire electrode to be melted are usually used, and in this case the wire electrode to be melted is guided by a current contact nozzle in order to apply the welding current to the wire electrode. The current contact nozzle itself is in a shield gas nozzle that is usually of sleeve-like construction through which the selected shield gas is guided past the current contact nozzle and the wire electrode to the weld point, so that the local environment around the generated electric arc is in a shield gas layer during welding.

The gas metal arc welding of this known type can be carried out both with manual guiding of a torch and also automated guiding of a torch, such that a weld following the welding path is usually produced by movement of the torch along this welding path.

In the prior art it is known that in gas metal arc welding in particular the starting end of the weld, which also coincides in terms of time with the start of the welding process, frequently has insufficient weld penetration and accordingly constitutes an unsatisfactory connection between the at least one workpiece to be welded and the metal material delivered by the wire electrode or also between two workpieces to be connected to one another.

In order to reduce this problem, in particular when a torch is guided on a self-contained welding path, as is the case for example when butt-welding pipe ends, attempts have been made to reduce the problem of lack of weld penetration at the starting end of the weld by an overlap between the starting end of the weld and the finish end of the weld. Investigations of the starting end of the weld, for example by cut samples and microsections, have however shown that such overlapping welding also does not completely solve the problem of the lack of weld penetration in the case of GMAW, in particular MAG welding.

Furthermore it has also become known in the prior art for a weld that has been produced by a GMAW welding method, that is to say under inert gas or also active gas, to be melted again without addition of a filler metal, specifically for example by passing over the weld with an ignited electric arc that burns between the at least one workpiece to be welded and a nonconsumable electrode.

Such a welding method, which is carried out with a nonconsumable electrode, is for example the so-called TIG welding method, in which a tungsten electrode is guided in a shield gas layer consisting of inert gas after ignition of the electric arc along the weld previously produced in the GMAW welding method. This should remelt melting the MIG weld, in particular MAG weld already produced previously and in this way should improve the weld penetration and equalize the weld. However, such methods prove complex and expensive because of the use of two different welding methods.

Furthermore, from EP 1 583 359 describes a torch head for gas metal arc welding that has a first torch for delivery of a melting wire electrode and a second torch with a nonconsumable stationary electrode where the two torches are mechanically connected to one another, the electrodes are in a common shield gas nozzle that can be supplied with shield gas, and the directions of the longitudinal extent of the electrodes intersect, in particular at an acute angle.

According to this document such a combined torch head is employed in order to produce a weld by simultaneously carrying out MIG and TIG welding processes, and this document says that TIG welding methods allow the MIG process to proceed, and thus during the entire welding process for production of a weld first of all the at least one workpiece is melted by the electric arc burning between the at least one workpiece and the nonconsumable electrode and then in the subsequent MIG welding method material from a melting wire electrode is delivered to the weld. Such a method using this known combined torch head is expensive and technically complex, since during the execution of a weld along a welding path the two torches of the combined torch head are continuously in operation and in this case the two simultaneously existing electric arcs can influence one another, so that here special provisions of a technical nature must be made for reciprocal shielding of the electric arcs.

The object of the invention is to improve a gas metal arc welding method of the above-described type, as well as a torch head with torches both for the delivery of a melting wire electrode and also for holding a nonconsumable electrode, in such a way as to overcome the problem of lack of weld penetration at the starting end of a weld to be produced in a GMAW method, in particular a MAG method.

In a development of the known method of gas metal arc welding this object is attained according to the invention in that at the location of the starting end of the weld to be produced, chronologically before ignition of the electric arc between the at least one workpiece and the melting wire electrode, first of all in a preceding step a nonconsumable electrode is moved toward the at least one workpiece, after which between the at least one workpiece and the nonconsumable electrode moved toward it, in a shield gas, in particular inert shield gas, an electric arc is ignited by which the at least one workpiece is preheated locally at the site where the weld is to be produced, and, after preheating, the nonconsumable electrode is removed from the at least one workpiece and after the removal the electric arc is ignited between the at least one workpiece and the melting wire electrode.

The essential core idea of the method according to the invention is that, only at the location of the starting end of a weld to be produced as a whole, which is produced along a welding path, in particular also a self-contained welding path, in the gas metal arc welding method that is to be carried out, first of all a local preheating of the at least one workpiece is carried out chronologically before ignition of the electric arc between the at least one workpiece and the melting wire electrode, so that then the gas metal arc welding method is carried out in an already preheated region of the at least one workpiece, in particular of two workpieces to be connected to one another.

In this case, in a preferred manner by comparison with the previously described prior art, at no time does a combined superimposition of two different welding methods take place, in particular no simultaneous existence of two electric arcs, as in the prior art of MIG and TIG welding methods, but at any time only one of these welding methods is carried out, and the chronologically preceding welding with a nonconsumable electrode under a shield gas atmosphere remains limited locally to the starting end of the weld.

Furthermore, in order to carry out this method the invention provides for the use of a torch head having both a first torch for delivery of a melting wire electrode and a second torch with a nonconsumable electrode, the constructive modification according to the invention ensuring that the torch of the nonconsumable electrode has a drive that longitudinally displaces the nonconsumable, in particular rod-like or needle-like electrode.

Thus there is not only the possibility of operating the two torches with the different electrode units chronologically one after the other, but also furthermore the possibility that the nonconsumable electrode for carrying out a chronologically subsequent MIG welding method along the weld to be produced is completely removed from the local sphere of influence of the electric arc between the melting wire electrode and the weld, since with the apparatus according to the invention the nonconsumable electrode can be advanced by the drive both toward the workpiece and also retracted away from the workpiece into the torch, in particular so that it is pulled completely outside the sphere of influence of the subsequently produced electric arc of the other torch.

Here preferably the nonconsumable electrode, such as for example a tungsten electrode with a preferably pointed lower end, can be moved to and fro by the drive between two end positions, for which corresponding stops between which the nonconsumable electrode is movable can be provided in the torch.

In this case according to the invention one of the end positions, specifically the lower end position in which an electric arc is ignited on the nonconsumable electrode, is at the intersection of the directions of the longitudinal extent of the two electrodes, that is to say both the melting wire electrode and also the nonconsumable electrode. This ensures that at the starting end of the weld the nonconsumable electrode is set exactly to the local position of the at least one workpiece to be welded at which chronologically thereafter the gas metal arc welding method then begins with the application of the melting wire electrode.

Ignition of the electric arc on the nonconsumable electrode can take place by high-voltage pulses with a space between the electrode tip and the at least one workpiece or also by contacting the at least one workpiece and subsequently retracting the electrode. The retraction can be done by moving the entire torch head or also only by moving the electrode for example by the drive.

After preheating has taken place before ignition of the electric arc on the melting wire electrode initially the nonconsumable electrode is retracted by the drive of the workpiece, in particular when the electric arc has already been extinguished solely by the retraction, or also by simultaneous or prior switching off of the current supply. Thus the electric arc on the melting wire electrode always ignites only after extinguishing of the electric arc on the nonconsumable electrode.

Furthermore, in this case, in the torch head according to the invention, the torch of the nonconsumable electrode has a mouth that is in the common shield gas nozzle and is closable, in particular by a pivotal valve flap, and through which mouth the tip of the nonconsumable electrode extends during movement between the end positions.

Thus for example according to the invention, during movement into the lower position required for welding, the nonconsumable electrode passes through the mouth and moves the valve out of its closed position into an open position. If on the other hand the nonconsumable electrode is retracted by the drive unit, then the invention may provide, for example by spring-loading of the valve, that this valve automatically closes the mouth again as soon as the tip with the nonconsumable electrode has passed through the mouth in the retraction direction.

Thus in this way it can be ensured that the mouth is automatically closed in the retracted position of the nonconsumable electrode and thus this electrode is located completely outside the sphere of influence of the electric arc when MIG welding is being carried out, and thus for example also cannot be contaminated by sprayed-out welding beads.

The drive specified here for movement of the nonconsumable electrode can in principle be constructed in any way whatsoever, for example powered by an electric motor, hydraulically or pneumatically, where “pneumatically” may be understood to mean not necessarily using compressed air, but generally compressed gas, in particular using at least the shield gas employed in the welding processes. Such a drive is preferably in each case constructed as a linear drive that linearly moves along the direction of extension of the nonconsumable electrode.

A particularly preferred embodiment of the torch head according to the invention may provide that the drive is constructed as a cylinder-piston assembly that in a further preferred embodiment is operated by a gas, such as for example with an inert shield gas, in particular an inert shield gas such as argon or helium, which can also be used for carrying out the local preheating at the starting end of the weld or also additionally for carrying out the further welding with a melting wire electrode.

When such a cylinder-piston assembly is used according to the invention the nonconsumable electrode is in a displaceable piston of this cylinder-piston assembly, for example disposed coaxially therein. A clamp, in particular by positive and or non-positive engagement between the electrode and the piston, can be provided here.

Thus by the application of pressure to the piston by the gas, such as for example an inert gas, the piston and thus the nonconsumable electrode can be moved.

In this case the invention may in principle provide that the piston of this cylinder-piston assembly can for example be reversibly acted on by with pressurized gas on two opposite piston faces so that the direction of movement of the piston is produced as a function of which piston face is currently subjected to the greater pressure. Advancing or retracting the nonconsumable electrode can then take place by mere reversal of the pressure.

An alternative embodiment can also provide here that the piston can be switchably supplied with pressurized fluid only on one piston face, for which purpose this piston face is in a piston chamber of the cylinder that can be supplied with pressure, and in the event of this application of pressure is displaced against a restoring spring force. If the application of pressure is then switched off and for example by valve actuation the piston chamber is relieved of pressure, for example to the external surroundings, then the piston and thus the nonconsumable electrode are turned by the spring force that can be exerted for example by a compression spring, and in this case in particular the nonconsumable electrode is moved away from the workpiece into the torch.

In the above-described embodiments particularly preferably the cylinder-piston assembly for driving the piston is connected in such a way that it can be switched off or switched over to an inert gas source, such as for example an argon or helium compressed gas source, that simultaneously is also the common shield gas tube or can be supplied with inert gas.

This ensures that even in the event of any leaks that are provided for in the design or are unintentional, in the event of a fault the entire torch head system is always only under the influence of inert gas, and thus no oxidizing damage to the nonconsumable electrode can occur.

As a result, particularly preferably, by the same compressed gas source the shield gas flushing with inert gas for preheating the starting end of the weld is carried out in accordance with the method according to the invention before the beginning of the MIG welding.

A development of the method according to the invention may provide that before ignition of the electric arc between the at least one workpiece and the nonconsumable electrode the wire electrode is retracted away from the workpiece and then only after this retraction of the nonconsumable electrode is advanced out of the torch toward the at least one workpiece, and the electric arc is ignited briefly, for example for less than 10 seconds, for local preheating at the starting end of the welding path and, after extinguishing this electric arc and in particular only after retracting the nonconsumable electrode, the melting wire electrode is again delivered to the at least one workpiece.

It may be provided here that the retraction of the melting wire electrode is carried out into the interior of the current contact nozzle so that also, while the preheating is carried out with the nonconsumable electrode, the lower end of the filler wire electrode is outside the electric arc and influences associated therewith.

A development according to the invention may provide here that, after locally preheating the starting end of the welding path, a sensor provided in the torch head, preferably in the torch of the melting wire electrode, determines the wire tip position in order to obtain information from this as to how far the melting wire electrode must be advanced for the beginning of the MIG welding.

Even without such a sensor, according to the invention a targeted advance can take place that is for example reduced in the advancing speed to the normal delivery speed during the MIG welding as a function of the measured current, which increases dramatically upon ignition of the electric arc.

Furthermore, in a preferred embodiment the method according to the invention may provide that ignition of the electric arc is carried out between the at least one workpiece and the melting wire electrode while a preheated region of the at least one workpiece is present at the location of the starting end of the weld after the removal of the nonconsumable electrode.

It may be provided here that this time interval between extinguishing of the electric arc on the nonconsumable electrode and ignition of the electric arc on the melting wire electrode is chosen to be in the range from 1/100 to 200/100 seconds. In a preferred embodiment the time interval may be chosen so that the local temperature of the workpiece at the starting end of the weld does not fall below 400° C.

Thus furthermore according to the invention it should preferably be ensured that with the drive described in the introduction a correspondingly quick retraction of the nonconsumable electrode from the welding position back into the torch can take place, in particular so that the entire movement between the two end positions, in particular during the retraction, lasts for a shorter time than the above-described maximum time interval between the extinguishing and ignition of the two above-described electric arcs on the two different electrodes.

This ensures that recooling of the workpiece preheating produced by the nonconsumable electrode and the electric arc produced thereby is reliably avoided and thus the MIG welding method always starts when it is certain that a preheated region exists at the starting end of the seam to be produced.

Furthermore the invention preferably provides that during the entire method step according to the invention, with local preheating produced at the starting end of the weld using an electric arc on the nonconsumable electrode, the torch head according to the invention is in a rest position relative to the at least one workpiece, and thus accordingly a travelling movement of a torch delivering the melting wire electrode, or in the event of use of the torch head according to the invention traveling of this entire torch head, only begins after extinguishing the electric arc between the nonconsumable electrode and the at least one workpiece and after starting of the electric arc between the melting wire electrode and the at least one workpiece. In particular it may be provided here that before the beginning of the travelling movement a residence time is provided in which the starting end of the weld is welded by infeed of the melting wire electrode.

In principle the method according to the invention can be used with any welding path, and a preferred embodiment may provide that the method according to the invention is implemented in particular using the torch head according to the invention in self-contained welding paths, since in this case a rationalization of the welding and qualitative optimization can take place not only through improvement of the weld penetration at the starting end of the weld but also, when the method according to the invention is used, an overlapping welding between the end of the finish weld and the starting end of the weld can be omitted.

Thus the welding method according to the invention, in particular using the torch head according to the invention, can for example preferably be used for butt-welding pipe ends both internally and also externally, and provision may be made for producing a weld internally by the method according to the invention and for providing a plurality of superimposed welds externally, where at least one, in particular the lowest, but preferably all of the weld layers can be implemented by the method according to the invention.

In particular with this butt-welding along a pipe surface both internal and also external, provision may be made to provide the pipe ends with chamfers internally and externally before they are butted against one another, where the inner chamfer may be smaller than the outer chamfer, so that an annular contact zone of the abutting pipe stubs or the end faces is displaced radially inward over the center of the pipe wall thickness. Thus for subsequently contacting the smaller internal chamfer of the abutting pipe ends can form a V-shaped groove that can be closed by one single weld layer, and the deeper, external V-shaped channel can be closed by a plurality of, in particular at least two weld layers.

In a preferred development of the torch head, according to which the torch head has a first gas connection, in particular for delivery of an inert gas, and a second gas connection, in particular for delivery of an active gas, and also has a controllable valve apparatus by means of which the first or the second gas connection can be connected alternatively to the shield gas nozzle, when the method according to the invention is carried out preferably the duration of the electric arc between the nonconsumable electrode and the at least one workpiece flushing of the starting end of the weld is carried out through the shield gas nozzle with inert shield gas, such as for example argon or helium, and for the duration of the electric arc between the melting wire electrode and the at least one workpiece flushing is carried out with active shield gas, in particular carbon dioxide or a mixture of carbon dioxide and argon, in particular when the gas supply into the common shield gas nozzle after extinguishing of the electric arc between the nonconsumable electrode and the at least one workpiece is switched from inert to active shield gas.

Thus welding along the welding path can be carried out as a MAG welding method, although the local preheating at the starting end of the weld has been handled under the influence of inert gas, for example as a TIG welding method.

A torch head according to the invention that can be used for carrying out the method according to the invention, but that is not limited in its application exclusively to carrying out this method, is explained in greater detail with reference to the sole FIGURE and described further below.

This FIGURE shows a torch head 6 of the type according to the invention that as shown the drawing has a torch 3 on the left side provided for MIG welding. The lower end of this torch 3 has a current contact nozzle 3a having a bore through which a melting wire electrode 1 can be fed to this nozzle 3a while in current contact.

A torch 7 that has a nonconsumable electrode, for example a tungsten electrode 2, extends at an angle to the travel path of the wire electrode 1. This electrode 2, which here is a rod, is displaceable by a drive 8 in the torch, in particular displaceable between two end positions that define the respective end positions of the displacement path. The direction of displacement is here along the center line of the nonconsumable electrode 2 and thus at the same previously mentioned angle α to the feed direction of the wire electrode 1. This angle α is preferably an acute angle smaller than 45°.

With the embodiment of the torch head according to the invention the tip 2a of the nonconsumable electrode 2 in the lower end position is preferably located exactly at the intersection 4 of the two feed directions of the wire electrode and the nonconsumable electrode.

In this embodiment the drive 8 is formed by a cylinder-piston assembly that is operated by a compressed gas, in particular a compressed inert gas, and in which a piston 8a is displaceable within the cylinder 8c. The embodiment described here makes it clear that in the annular space 8 the back piston face 8b is subjected to force by an application of pressure by the gas, in particular the inert gas such as argon or helium, and is displaceable toward the workpiece against a restoring force of a spring 11 acting on an opposite front piston face.

If the application of pressure to the annular space 8d is switched off, for example by closing a valve and relieving pressure from the annular space into the surroundings, then the piston 8a, which here holds the nonconsumable electrode coaxially, is retracted into a retracted position.

In this case the nonconsumable electrode 2 can be held in the piston 8a for example by a collet.

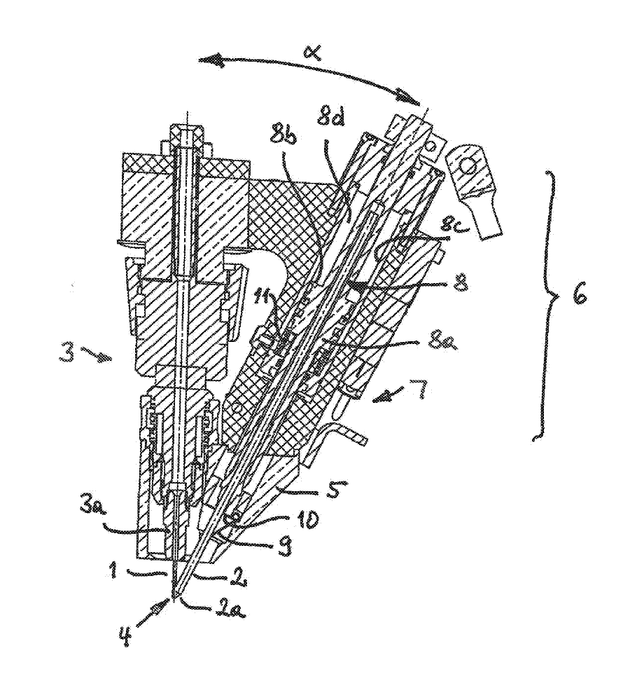

FIG. 1 also makes it clear that in the illustrated position the lower tip of the nonconsumable electrode 2 has passed through a mouth 10 of the torch 7 and in this case has displaced a valve 9 into an open position. Here the invention provides that the valve 9 has a spring biasing it into a closed position in which the valve 9 here simultaneously is engaged with the electrode 2. Accordingly retraction of the nonconsumable electrode 2 through the mouth 10 back into the torch automatically closes the valve 9 and thus the electrode tip 2a of the nonconsumable electrode 2 is located outside any influence by an electric arc or a welding process of the torch 3.

The invention can provide in principle that for displacement of the piston the cylinder-piston assembly can be operated by any gas, in an alternative embodiment also by a liquid. Furthermore, in the event of operation by a gas, it is preferably provided that the inert gas is used as working fluid and is simultaneously also used for flushing the pressure head through the common shield gas nozzle 5 while the preheating is carried out before the beginning of a GMAW welding method with the melting wire 1.

Although not shown, the invention may provide that the torch head has gas feeds both for an inert gas such as argon or helium and also for an active gas such as for example carbon dioxide or a mixture of carbon dioxide and argon, and a switching valve can supply the interior of the shield gas nozzle 5 with the gas from one or the other of the two gas supplies.

Accordingly it is possible to carry out the local preheating at the starting end of a weld using the nonconsumable electrode while flushing with inert gas, and then after extinguishing the electric arc from this nonconsumable electrode the gas supply of the shield gas nozzle 5 is switched over from inert gas to an active gas, such as carbon dioxide or a mixture of carbon dioxide and argon from the other gas feed.

Thus the subsequent shield-gas welding method can be carried out for example under active gas as a MAG welding method. While retaining the shield gas flushing with inert gas, on the other hand, the subsequent GMAW welding method is carried out as MIG welding.

Thus it can be seen that with a torch head according to FIG. 1, both welding methods can be carried out with the one torch 3 and also with the other torch 7 chronologically one after the other, in particular for carrying out the method according to the invention, and welding, in particular local preheating, is carried out by the torch 7 only at the starting end of a weld and chronologically before the GMAW welding process.

1. In a method of gas metal arc welding in which an electric arc burns in a shield gas environment during the welding for production of a weld along a welding path between at least one workpiece to be welded and a melting wire electrode that is continuously delivered to the at least one workpiece, the improvement comprising the steps of:
at the location of the starting end of the weld to be produced, chronologically before ignition of the electric arc between the at least one workpiece and the wire electrode moving a nonconsumable electrode toward the at least one workpiece,
between the at least one workpiece and the nonconsumable electrode and in a shield gas environment igniting an electric arc to locally preheat the at least one workpiece at the starting end of the weld to be produced,
after the preheating, removing the nonconsumable electrode from the at least one workpiece, and
after the removal of the nonconsumable electrode igniting the electric arc ignited between the at least one workpiece and the wire electrode.

2. The method according to claim 1, wherein preheating is carried out:
a) up to a temperature below the transformation temperature of the structure of the at least one workpiece,
b) up to a temperature below the melting temperature of the at least one workpiece and above a temperature from which a transformation of the structure of the at least one workpiece is carried out, or
c) up to and beyond a temperature above which the at least one workpiece melts.

3. The method according to claim 2, wherein ignition of the electric arc between the at least one workpiece and the wire electrode is carried out:
within n100 seconds after extinguishing of the electric arc on the nonconsumable electrode with n<100,
at a time when the at least one workpiece has reached a temperature below the transformation temperature,
at a time at which a melt of the at least one workpiece is still present at the location of the starting end of the weld.

4. The method according to claim 1, wherein a traveling movement in the welding direction of a torch delivering the melting wire electrode only begins after extinguishing the electric arc between the nonconsumable electrode and the at least one workpiece and after starting of the electric arc between the melting wire electrode and the at least one workpiece.

5. The method according to claim 1, further comprising the step, before ignition of the electric arc between the at least one workpiece and the nonconsumable electrode, of:
retracting the wire electrode and feed the wire electrode again to the at least one workpiece after extinguishing of this electric arc.

6. The method according to claim 1, wherein the melting wire electrode and the nonconsumable electrode are fed on feed paths that intersect at an acute angle to each other and the intersection of the two feed paths is located
within the material thickness of the at least one workpiece to be welded or
exactly in the surface plane or
above the surface plane of the at least one workpiece to be welded.

7. The method according to claim 1, further comprising the step of:
containing the melting wire electrode and the nonconsumable electrode during movement within a common shield gas nozzle that is flushed with shield gas.

8. The method according to claim 7, wherein, for the duration of the electric arc between the nonconsumable electrode and the at least one workpiece, flushing of the starting end of the weld is carried out through the shield gas nozzle with inert shield gas, and for the duration of the electric arc between the melting wire electrode and the at least one workpiece flushing is carried out with active shield gas, with the gas supply into the common shield gas nozzle after extinguishing of the electric arc between the nonconsumable electrode and the at least one workpiece being switched over from inert to active shield gas.

9. A torch head for gas metal arc welding comprising:
a first torch for delivery of a melting wire electrode;
a second torch with a nonconsumable electrode, the two torches being mechanically connected to one another;
a common shield gas nozzle that can be supplied with shield gas and the directions of the longitudinal extent of the electrodes intersect; and particular at an acute angle,
a drive in the second torch for displacing the nonconsumable electrode longitudinally.

10. The torch head according to claim 9, wherein the nonconsumable electrode, can be moved by the drive between two end positions in one of which the tip of the nonconsumable electrode is at the intersection of the directions of the longitudinal extents of the two electrodes.

11. The torch head according claim 9, wherein the torch of the nonconsumable electrode has a mouth in the common shield gas nozzle and closable, by a pivotable valve, and through which the tip of the nonconsumable electrode is passed during movement between the end positions such that in one of the end positions the mouth is closed automatically by application of an actuating force to the valve.

12. The torch head according to claim 9, wherein the drive is
a cylinder-piston assembly operated by an gas and the nonconsumable electrode, is preferably coaxially in a displaceable piston or
an electromagnetic lifting drive in which the nonconsumable electrode is in a magnetic or magnetizable element that is movable in an electromagnetic reversible field.

13. The torch head according to claim 12, wherein the piston
can be reversibly supplied with pressurized fluid on two piston faces that are opposite one another, or
can be controlledly supplied with pressurized fluid on a piston face against a restoring spring force.

14. The torch head according to claim 13, wherein the cylinder-piston assembly for driving the piston is connected such that it can be switched off or switched over to an inert gas source by which simultaneously the common shield gas nozzle is or can be supplied with inert gas.

15. The torch head according to claim 9, wherein the torch of the melting wire electrode has a sensor for determining the wire tip position after retraction of the wire electrode.

16. The torch head according to claim 16, wherein the torch head has a first gas connection for delivery of an inert gas, and a second gas connection for delivery of an active gas, and also has a controllable valve that can connect the first or the second gas connection to the shield gas nozzle.
